(19) United States
(12) Patent Application Publication
(10) Pub. No.: US 2011/0242043 A1
(43) Pub. Date: Oct. 6, 2011

(54) DEVICE WITH CAPACITIVE TOUCHSCREEN PANEL AND METHOD FOR POWER MANAGEMENT

(76) Inventors: Mark Yarvis, Portland, OR (US); David L. Graumann, Portland, OR (US); Steven S. Bateman, Portland, OR (US)

(21) Appl. No.: 12/754,632

(22) Filed: Apr. 6, 2010

(51) Int. Cl. G06F 3/045; G06F 3/043

(52) U.S. Cl. 345/174; 345/177

(57) ABSTRACT

Embodiments of a device having a touchscreen panel and method for reducing power consumption are generally described herein. The touch-sensing capability of the touchscreen panel is activated when user interaction with the touchscreen panel is detected. The touch-sensing capability of the touchscreen panel is deactivated when no user interaction is detected. In some embodiments, the device includes a touch-event detector to sense motion or vibration, and processing circuitry to either activate or deactivate touch-sensing capability of the touchscreen panel based at least in part on input from the touch-event detector.

### TECHNICAL FIELD

Embodiments relate to devices with touchscreen panels including capacitive touchscreen panels. Some embodiments relate to wireless communication devices with touchscreen panels. Some embodiments relate to power management in a device with a touchscreen panel, including a portable communication device with a touchscreen panel.

### BACKGROUND

Touchscreen panels allow a user to interact with a device via touch including both single touch and multi-touch. Capacitive touchscreen panels employ a surface-capacitive interface to detect user interaction, however the surface-capacitive interface can be power hungry because it is actively charged and discharged in a scan cycle that proceeds across the panel. Any resulting data is processed via signal-processing algorithms to determine the user's intent. This scan cycle can waste energy, particularly when a user is not interacting with the touchscreen panel. Wasted energy is a concern particularly in the case of portable communication devices that rely on battery power.

Thus there are general needs for devices with touchscreen panels with reduced power consumption and methods for power management in devices with touchscreen panels.

### BRIEF DESCRIPTION OF THE DRAWINGS

FIG. 1 is a diagram of a device with a touchscreen panel in accordance with some embodiments; and

FIG. 2 is a procedure for power management in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

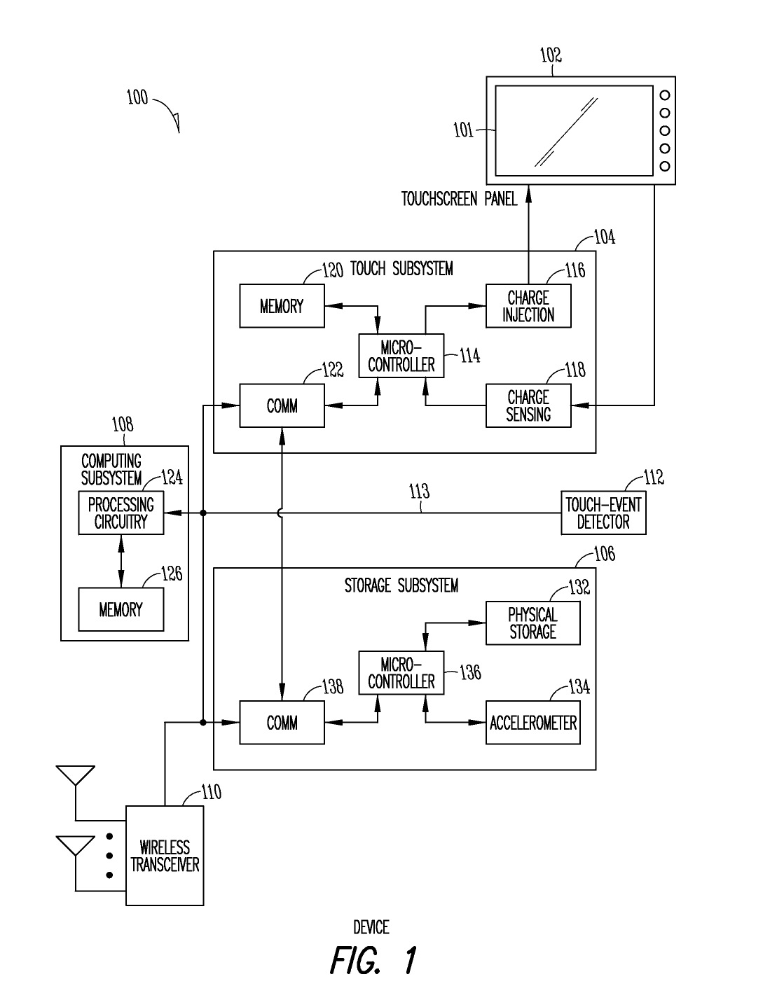

FIG. 1 is a diagram of a device 100 with a touchscreen panel 102 in accordance with some embodiments. The touch-sensing capability of the touchscreen panel 102 may be activated when user interaction with the touchscreen panel 102 is detected. The touch-sensing capability of the touchscreen panel 102 may be deactivated when user interaction is not detected. In some embodiments, the device 100 includes a touch-event detector 112 to sense motion or vibration and processing circuitry 124 to either activate or deactivate touch-sensing capability of the touchscreen panel 102 based, at least in part, on input 113 from the touch-event detector 112. The input 113 from the touch-event detector 112 is used by the processing circuitry 124 to determine whether there is user interaction with the touchscreen panel 102. User interaction may be referred to as a touch event.

In these embodiments, the processing circuitry 124 may deactivate the touch-sensing capability of the touchscreen panel 102 when no user interaction is detected, for example, for a predetermined period of time. The processing circuitry 124 may active or reactivate the touch-sensing capability of the touchscreen panel 102 when input 113 from the touch-event detector 112 indicates that there is user interaction with the touchscreen panel 102.

Touchscreen panel 102 may include a display portion 101 to display content and other information. The display portion 101 of the touchscreen panel 102 may be active and able to display content and other information whether or not the touch-sensing capability the touchscreen panel 102 is active. In some embodiments, when the display portion 101 is inactive (i.e., in a power savings or a sleep mode), the touch-sensing capability of the touchscreen panel 102 may be deactivated. The display portion 101 may be a high-definition or graphical display to display images, icons, and characters as well as other items.

In accordance with embodiments, when a user is not touching or interacting with the touchscreen panel 102, no vibration or motion may be detected and the touch-sensing capability of the touchscreen panel 102 may be deactivated. When a user is touching or interacting with the touchscreen panel 102, vibration and/or motion may be detected and the touch-sensing capability of the touchscreen panel 102 may be activated. Because the touch-sensing capability of the touchscreen panel 102 is not active when it is determined that there is no user interaction, power consumption of device 100 may be significantly reduced. As discussed in more detail below, the processing circuitry 124 may process the input 113 and may execute one or more algorithms to determine whether there is user interaction.

In some embodiments, the processing circuitry 124 may activate the touch-sensing capability of the touchscreen panel 102 when the input 113 from the touch-event detector 112 indicates that a user is about to interact with the touchscreen panel 102. These embodiments are described in more detail below.

As illustrated in FIG. 1, device 100 may include a touch subsystem 104, a storage subsystem 106 and a computing subsystem 108. In wireless embodiments, device 100 may be a wireless communication device and may include a wireless transceiver 110 for communicating within a wireless network or with other wireless devices. The computing subsystem 108 may control the operations of device 100 and may include the processing circuitry 124 and a memory 126, among other things. The touch subsystem 104 may control the operations of the touchscreen panel 102 and may provide user input from the touchscreen panel 102 to the computing subsystem 108. The storage subsystem 106 may provide for storage of information within device 100. The operations and the various elements of these subsystems are described in more detail below.

In some embodiments, the processing circuitry 124 may process the input 113 from the touch-event detector 112 to determine whether there is user interaction with the touchscreen panel 102 by distinguishing user taps including a sequence of user taps from other vibrations and motions that may be sensed by the touch-event detector 112. In these embodiments, when the input 113 from the touch-event detector 112 is a constant or near constant signal with little fluctuation, the input 113 may be determined by the processing circuitry 124 to indicate that the device 100 is resting or not in use. Therefore, the touch-sensing capability of the touchscreen panel 102 does not need to be activated. Relatively large changes over a large timeframe in the input 113 from the touch-event detector 112 may indicate that the device is being carried and, therefore, the touch-sensing capability of the touchscreen panel 102 does not need to be activated.

In some embodiments, the processing circuitry 124 may distinguish user taps from other vibrations and motions by determining whether the input 113 received from the touch-event detector 112 comprises relatively small changes in a single directional vector over a relatively short timeframe. In these embodiments, the detection of user taps or a sequence of user taps may indicate that there is user interaction with the touchscreen panel 102 and, therefore, the touch-sensing capability of the touchscreen panel 102 may be activated.

In embodiments that include touch subsystem 104, the processing circuitry 124 may either activate or deactivate the touch-sensing capability of the touchscreen panel 102 by either activating or deactivating the touch subsystem 104 based at least in part on the input 113 from the touch-event detector 112. When the touch subsystem 104 has been deactivated, it may be in a sleep mode or may be considered sleeping. When the touch subsystem 104 is deactivated, the processing circuitry 124 may process the input 113 from the touch-event detector 112 to determine whether there is user interaction with the touchscreen panel 102 and activate the touch subsystem 104 when it determines that there is user interaction with the touchscreen panel 102 based on the processed input.

In some embodiments, when the touch subsystem 104 is active (e.g., in active mode, not in sleep mode, not asleep), the processing circuitry 124 may detect user interaction (i.e., touch events) with the touchscreen panel 102 and may refrain from deactivating the touch subsystem 104 while user interaction is detected. The processing circuitry 124 may also deactivate the touch subsystem 104 when no user interaction with the touchscreen panel 102 is detected for at least a predetermined period of time. In these embodiments, when the touch subsystem 104 is active, the touch subsystem 104 may actively scan the touch surface of the touchscreen panel 102. The predetermined period of time may range from one to thirty seconds, for example. In some embodiments, the predetermined period of time may be a predetermined number of scan cycles. In some embodiments, a timer may be set or reset when a touch event is detected that may expire after the predetermined period of time.

In some embodiments, the processing circuitry 124 (i.e., in addition to the touch subsystem 104) may be configured to enter a sleep state or lower-power state when no user interaction with the touchscreen panel 102 is detected for at least the predetermined period of time. In these embodiments, additional power consumption reduction may be achieved because both the touch subsystem 104 and the processing circuitry 124 consume less power. In these embodiments, when the processing circuitry 124 is in a sleep state, the processing circuitry 124 may be activated by an interrupt generated by the touch-event detector 112 or other motion-sensing device.

In some embodiments, the processing circuitry 124 may activate the touch-sensing capability of the touchscreen panel 102 when input 113 from the touch-event detector 112 indicates that a user is about to interact with the touchscreen panel 102 by detecting relatively large motion changes over a short period of time in the input 113 from the touch-event detector 112. Relatively large changes in motion detected over a short period of time may indicate, for example, that the device is being moved into a position to be used. The processing circuitry 124 may also activate the touch-sensing capability of the touchscreen panel 102 when input 113 from the touch-event detector 112 indicates that a user is currently attempting to interact with the touchscreen panel 102 by detecting relatively small motion changes along a single axis over a short period of time in the input 113 from the touch-event detector 112. Relatively small changes in motion along a single axis detected over a short period of time may indicate, for example, that the user has tapped on the device. One or more algorithms may be employed to determine when a user is about to interact with or is currently trying to interact with the touchscreen panel 102. In these embodiments, when the processing circuitry 124 determines that a user is about to interact with or is currently trying to interact with the touchscreen panel 102, the processing circuitry may partially activate the touch-sensing capability of the touchscreen panel 102 and set a timer. The processing circuitry 124 may fully-activate the touch-sensing capability of the touchscreen panel 102 if user interaction is actually detected before expiration of the timer. The touch-sensing capability of the touchscreen panel 102 may be deactivated if user interaction is not detected before a predetermined period of time (i.e., before the expiration of the timer).

In these embodiments that may activate the touch-sensing capability of the touchscreen panel 102 when a user is about to interact with the touchscreen panel 102, the touch-sensing capability of the touchscreen panel 102 may be partially activated when it is determined that touchscreen panel 102 may be about to be touched. When the touch-sensing capability of the touchscreen panel 102 is partially activated, a lower-duty cycle scan cycle may be used. This may allow several cycles of scanning before deactivation if user interaction is not detected before expiration of the timer. In these embodiments, the processing circuitry 124 may detect user interaction based on actual user input to the touchscreen panel 102 (e.g., a user selection on the panel) or on input 113 from the touch-event detector 112 indicating user interaction.

In some embodiments, the touch-event detector 112 may comprise one or more accelerometers. In some embodiments, a two-axis or three-axis accelerometer may be used for the touch-event detector 112. In some embodiments, the one or more accelerometers may be included within the device 100 and used for one or more other purposes. In some embodiments, the touch-event detector 112 may be coupled directly to the touchscreen panel 102 to sense motion or vibrations. In some embodiments, a touch-event detector coupled directly to the touchscreen panel 102 may be used along with the accelerometer 134 to sense motion or vibrations.

In some embodiments, the storage subsystem 106 may include a physical storage 132, an accelerometer 134, a microcontroller 136 and a communications interface (COMM) 138. Physical storage 132 may be a hard-disc drive that may be automatically parked when a fall is detected by accelerometer 134. In some embodiments, the accelerometer 134 may be used as a touch-event detector and the output from the accelerometer 134 may be additionally provided to the processing circuitry 124. In other embodiments, the touch-event detector 112 may be a separate sensor device as illustrated in FIG. 1.

In some embodiments, the touch subsystem 104 may include charge-injection circuitry 116, charge-sensing circuitry 118, and a microcontroller 114. The charge-injection circuitry 116 may apply charge to portions of the touchscreen panel 102. The charge-sensing circuitry 118 may detect charge or capacitance changes on portions of the touchscreen panel 102 that result from user interaction with the touchscreen panel 102. The microcontroller 114 may generate data resulting from the detected changes in capacitance indicated by the charge-sensing circuitry 118. The touch subsystem 104 may also include memory 120 and communications interface (COM) 122.

In these embodiments, when the touchscreen panel 102 is active, the microcontroller 114 may cause the charge-injection circuitry 116 to periodically charge-up capacitive elements on the touchscreen panel 102. When the touchscreen panel 102 is active, the microcontroller 114 may also cause the charge-sensing circuitry 118 to discharge the capacitive elements and measure any capacitive charge. The microcontroller 114 may execute a periodic scan cycle to charge and discharge the capacitive elements to detect user interaction and receive user input from the touchscreen panel 102. Changes in charge may be used to identify one or more locations on the touchscreen panel 102 that a user has touched. This scan cycle may proceed across the touchscreen panel 102 and may be performed periodically or regularly. In some embodiments, each row of capacitive elements may be sequentially charged and each column may be discharged and measured. As can be appreciated, this scan cycle is wasteful and consumes excess power when there is no user interaction with the touchscreen panel 102.

To deactivate the touch subsystem 104, the processing circuitry 124 may instruct the microcontroller 114 to enter a sleep state although this is not a requirement. The microcontroller 114 may be activated by an interrupt when the processing circuitry 124 activates the touch subsystem 104. In some embodiments, the processing circuitry 124 either activates or deactivates the touch-sensing capability of the touchscreen panel 102 by either activating or deactivating the charge-injection circuitry 116, the charge-sensing circuitry 118 and the microcontroller 114 based on the inputs from the touch-event detector 112. In other embodiments, the processing circuitry 124 either activates or deactivates the touch-sensing capability of the touchscreen panel 102 by instructing the microcontroller 114 to refrain from scanning and to enter a sleep state or lower power state.

In some embodiments, when the touch-sensing capability of the touchscreen panel 102 and the display portion 101 are both asleep, an initial input by a user may be missed or not detected. In these embodiments, user input may be delayed until the touchscreen panel 102 is activated.

In some embodiments, when the touch-sensing capability of the touchscreen panel 102 is deactivated but the display portion 101 is active, a visual indicator, such as a touchscreen-inactive indicator discussed below, may be provided. In these embodiments, because the display portion 101 is active, a user may know where to touch and because the input 113 may be processed quickly relative the user interaction (e.g., the dwell time of a user's finger on the touchscreen panel 102), the user input may be detected. In these embodiments, visual feedback may be provided to indicate to the user whether the touch had been detected.

In some embodiments, when the touch-sensing capability of the touchscreen panel 102 is deactivated but the display portion 101 is active, a visual indicator is combined with a guard band (e.g., of a few hundred milliseconds) after the initial vibration is detected to prevent an initial quick tap from registering as a real touch. After this time, the visual indicator may be removed and touches may be sensed. In these embodiments, when visual feedback indicates that the touchscreen panel 102 is asleep, a user can tap anywhere to activate that touchscreen panel 102, the indicator goes away, and then the user they can interact with the touchscreen panel 102.

In some embodiments, a touchscreen-inactive indicator may indicate when the touch-sensing capability of the touchscreen panel 102 is deactivated (i.e., touch asleep). The touchscreen-inactive indicator may comprise an alpha blended band around the edge of the screen of the display portion 101, although this is not a requirement. The use of the touchscreen-inactive indicator allows the user to know that the touch-sensing capability of the touchscreen panel 102 is presently deactivated and accordingly, the user may tap the touchscreen panel 102 to activate the touch-sensing capability. In these embodiments, the touchscreen-inactive indicator may be removed when the touch-sensing capability of the touchscreen panel 102 is active or when it is activated.

In some embodiments, the touch-sensing capability of the touchscreen panel 102 may be deactivated automatically when the touchscreen touchscreen panel 102 is displaying media such as movie. In these embodiments, when an alpha blended band is used as the touchscreen-inactive indicator, the indicator may not be used when the display portion 101 is rendering full screen media (e.g., a high-definition movie) so as not to interfere with the content.

In wireless embodiments, the wireless transceiver 110 may be a Wi-Fi transceiver that operates in accordance with one of the IEEE 802.11 standards, a WiMAX transceiver that operates in accordance with one of the IEEE 802.16 standards, a 3GPP-LTE E-UTRAN transceiver, a GSM transceiver, a CDMA transceiver, or other wide-area or local-area wireless communication transceiver. In these embodiments, the device 100 may be a personal digital assistant PDA, a laptop or portable computer with wireless communication capability, a web tablet, a wireless telephone, a smart phone, a pager, an instant messaging device, a digital camera, a television, or other device that may receive and/or transmit information wirelessly. Although several embodiments describe device 100 as a wireless communication device, this is not a requirement as device 100 may be a stand-alone device or configured to communicate over a wired interface such as a LAN or telephone line.

In wireless embodiments, device 100 may utilize one or more directional or omnidirectional antennas, including, for example, dipole antennas, monopole antennas, patch antennas, loop antennas, microstrip antennas or other types of antennas suitable for transmission of radio-frequency (RF) signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated to take advantage of spatial diversity and the different channel characteristics that may result between each of the antennas and the antennas of another communication station.

Although device 100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, application specific integrated circuits (ASICs), radio-frequency integrated circuits (RFICs) and combinations of various hardware and logic circuitry for performing at least the functions described herein. In some embodiments, the functional elements of the device 100 may refer to one or more processes operating on one or more processing elements. The processing circuitry 124, for example, may comprise one or more processors.

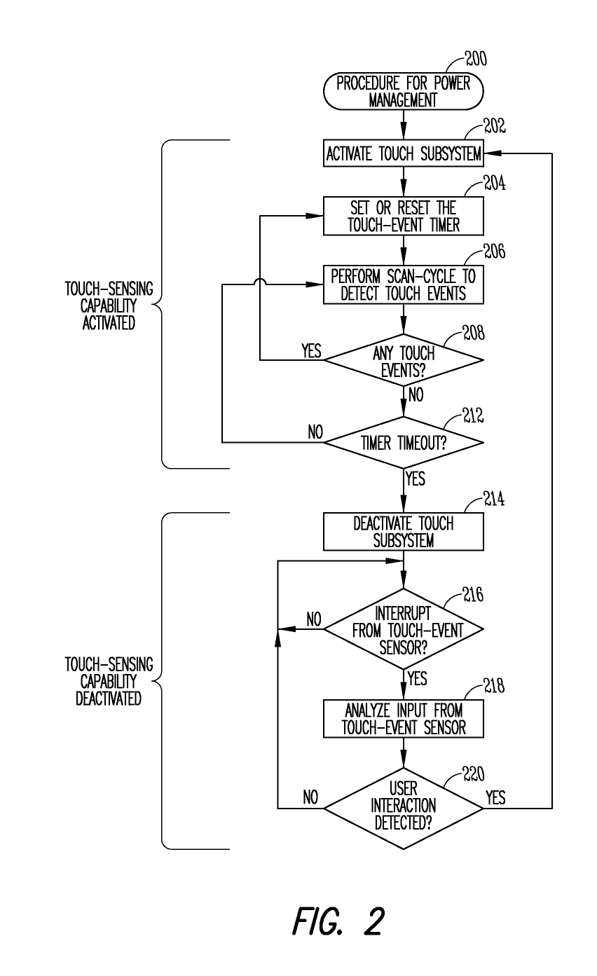

FIG. 2 is a procedure for power management in accordance with some embodiments. Procedure 200 may be performed by a device, such as device 100 (FIG. 1), although this is not a requirement.

In operation 202, the touch-sensing capability of the touchscreen panel 102 (FIG. 1) is activated. In some embodiments, touch subsystem 104 (FIG. 1) may be activated.

In operation 204, a touch-event timer is either set or reset. The touch-event timer may be implemented by processing circuitry 124 (FIG. 1) or implemented within computing subsystem 108 (FIG. 1).

In operation 206, a scan cycle is performed to detect user interaction with the touchscreen panel 102. In some embodiments, rows may be charged and columns may be sensed to detect changes in capacitance. In some embodiments, operation 206 may be performed by charge-injection circuitry 116 (FIG. 1) and charge-sensing circuitry 118 (FIG. 1). When the scanning cycle is complete, operation 208 may be performed.

In operation 208, data resulting from the scanning (i.e., scan data) may be analyzed and any touch events may be indicated. In some embodiments, operation 208 may be performed by microcontroller 114 (FIG. 1) and may provide an indication of any touch events to processing circuitry 124 (FIG. 1). If any touch events have occurred, operation 204 is performed in which the touch-event timer is reset. If no touch events have occurred, operation 212 is performed.

Operation 212 determines whether or not the touch-event timer has expired (i.e., a timer timeout has occurred). Expiration of the touch-event timer indicates that no touch events have occurred for at least a predetermined period time. When operation 212 determines that the touch-event timer has expired, operation 214 is performed. When operation 212 determines that the touch-event timer has not expired, operation 206 is performed.

In operation 214, the touch-sensing capability of the touchscreen panel 102 is deactivated. In some embodiments, touch subsystem 104 may be deactivated or placed in sleep mode as discussed above.

Operation 216 determines if an interrupt from a touch-event sensor, such as the touch-event detector 112 (FIG. 1), has occurred. When no interrupt occurs, the touch-sensing capability of the touchscreen panel 102 remains deactivated (i.e., touch sleeping). When operation 216 detects an interrupt, operation 218 is performed.

In operation 218, the input from the touch-event sensor is analyzed to determine whether there is user interaction with the touchscreen panel 102. In some embodiments, in operation 218, the input from the touch-event sensor is analyzed to determine whether a user is about to interact (i.e., user interaction is likely) or is currently interacting with the touchscreen panel 102.

Operation 220 determines whether or not operation 218 had detected user interaction or had determined that user interaction was likely. When user interaction had not been detected or had not been determined to be likely, the touch-sensing capability of the touchscreen panel 102 remains deactivated and operations 216-220 are repeated. When operation 220 determines that user interaction had been detected or that user interaction was likely, operation 202 is performed in which the touch-sensing capability of the touchscreen panel 102 is activated.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A device having a touchscreen panel, the device comprising:
a touch-event detector to sense motion or vibration; and
processing circuitry to either activate or deactivate touch-sensing capability of the touchscreen panel based at least in part on input from the touch-event detector,
wherein the input from the touch-event detector is used by the processing circuitry to determine whether there is user interaction with the touchscreen panel.

2. The device of claim 1, wherein the processing circuitry is further configured to process the input from the touch-event detector to determine whether there is user interaction with the touchscreen panel by distinguishing one or more user taps from other vibrations and motions.

3. The device of claim 2, wherein the processing circuitry is further configured to distinguish user taps from other vibrations and motions by determining whether the input received from the touch-event detector comprises relatively small changes in a single directional vector over a relatively short timeframe.

4. The device of claim 2, further comprising a touch subsystem coupled to the touchscreen panel,
wherein the processing circuitry either activates or deactivates the touch-sensing capability of the touchscreen panel by either activating or deactivating the touch subsystem based at least in part on the input from the touch-event detector,
wherein when the touch subsystem has been deactivated, the processing circuitry is configured to:
process input from the touch-event detector to determine whether there is user interaction with the touchscreen panel; and
activate the touch subsystem when the processing circuitry determines that there is user interaction with the touchscreen panel based on the processed input.

5. The device of claim 4, wherein when the touch subsystem is active, the processing circuitry is configured to:
detect user interaction with the touchscreen panel;
refrain from deactivating the touch subsystem while user interaction is detected; and
deactivate the touch subsystem when no user interaction with the touchscreen panel is detected for at least a predetermined period of time.

6. The device of claim 5, wherein to deactivate the touch subsystem, the processing circuitry is configured to instruct a microcontroller of the touch subsystem to enter a sleep state, and
wherein the microcontroller is activated by an interrupt when the processing circuitry activates the touch subsystem.

7. The device of claim 2, wherein the processing circuitry is further configured to activate the touch-sensing capability of the touchscreen panel when input from the touch-event detector indicates that a user is about to interact with the touchscreen panel by detecting relatively large motion changes over a short period of time in the input from the touch-event detector.

8. The device of claim 7, wherein when the processing circuitry determines that the user is about to interact with the touchscreen panel, the processing circuitry is further configured to:
partially activate the touch-sensing capability of the touchscreen panel;
set a timer;
fully-activate the touch-sensing capability of the touchscreen panel if user interaction is detected before expiration of the timer; and
deactivate the touch-sensing capability of the touchscreen panel if user interaction is not detected before the expiration of the timer.

9. The device of claim 1, wherein the touch-event detector comprises one or more accelerometers.

10. The device of claim 1, wherein the touch-event detector comprises an accelerometer that is also used to detect falls and provide automatic disk parking.

11. The device of claim 4, wherein the touchscreen panel is a capacitive touchscreen panel,
wherein the touch subsystem comprises:
charge-injection circuitry to apply charge to portions of the touchscreen panel;
charge-sensing circuitry to detect charge changes on portions of the touchscreen panel resulting from user interaction with the touchscreen panel; and
a microcontroller to cause the charge-injection circuitry and the charge-sensing circuitry to perform a scan and generate data resulting from the charge changes detected on portions of the touchscreen panel indicated by the charge-sensing circuitry,
wherein the processing circuitry deactivates the touch subsystem by instructing the microcontroller to inhibit the charge-injection circuitry and the charge-sensing circuitry from scanning the touchscreen panel.

12. The device of claim 11, wherein the processing circuitry deactivates the touch subsystem by instructing the microcontroller to enter a sleep state.

13. The device of claim 1, wherein a touchscreen-inactive indicator is used to indicate when the touch-sensing capability of the touchscreen panel is deactivated.

14. The device of claim 13, wherein the touchscreen-inactive indicator comprises an alpha blended band around an edge of a screen of the touchscreen panel.

15. A method for power management in a device having a touchscreen panel, the method comprising:
activating a touch-sensing capability of the touchscreen panel when user interaction with the touchscreen panel is detected; and
deactivating the touch-sensing capability of the touchscreen panel when no user interaction is detected.

16. The method of claim 15, further comprising detecting user interaction based on input from a touch-event detector that senses motion or vibration,
wherein the touch-sensing capability of the touchscreen panel is activated when user interaction is detected by distinguishing one or more user taps from other vibrations and motions sensed by the touch-event detector, and
wherein the touch-sensing capability of the touchscreen panel is deactivated when no user interaction is detected for at least a predetermined period of time.

17. The method of claim 16, wherein detecting user interaction further includes distinguishing user taps from other vibrations and motions by determining whether the input received from the touch-event detector comprises relatively small changes in a single directional vector over a relatively short timeframe.

18. The method of claim 15, wherein the touchscreen panel is a capacitive touchscreen panel, and
wherein deactivating the touch-sensing capability of the touchscreen panel comprises instructing a microcontroller to inhibit charge-injection circuitry and the charge-sensing circuitry from scanning the touchscreen panel.

19. The method of claim 18, wherein deactivating the touch-sensing capability of the touchscreen panel comprises instructing the microcontroller to enter a sleep state.

20. A wireless communication device comprising:
a touchscreen panel;
processing circuitry configured to activate a touch-sensing capability of the touchscreen panel when user interaction with the touchscreen panel is detected and to deactivate the touch-sensing capability of the touchscreen panel when no user interaction is detected; and
a wireless transceiver coupled to the processing circuitry.

21. The wireless communication device of claim 20, further comprising a touch-event detector to sense motion or vibration,
wherein the processing circuitry is configured to either activate or deactivate the touch-sensing capability of the touchscreen panel based at least in part on input from the touch-event detector.

22. The wireless communication device of claim 21, wherein the processing circuitry is configured to process the input from the touch-event detector to determine whether there is user interaction with the touchscreen panel by distinguishing one or more user taps from other vibrations and motions by determining whether the input comprises relatively small changes in a single directional vector over a relatively short timeframe.
